(19) United States
(12) Patent Application Publication
(10) Pub. No.: US 2015/0223440 A1
(43) Pub. Date: Aug. 13, 2015

(54) SYSTEMS AND APPARATUSES FOR RETAINING AND POSITIONING FISHING DEVICES

(71) Applicant: Joseph H. Schmaus, Helena, MT (US)

(72) Inventor: Joseph H. Schmaus, Helena, MT (US)

(21) Appl. No.: 14/621,227

(22) Filed: Feb. 12, 2015

Related U.S. Application Data
(60) Provisional application No. 61/938,820, filed on Feb. 12, 2014.

(51) Int. Cl. A01K 97/10; A01K 97/11; A01K 97/12; A01K 99/00; A01K 97/00

(52) U.S. Cl. CPC A01K 97/10; A01K 99/00; A01K 97/00; A01K 97/12; A01K 97/11

(57) ABSTRACT

Devices hold and move fishing rods without human intervention. Fishing rods can be retained by a holder that permits easy insertion and adjustment of a fishing rod between opposite yokes but otherwise securely keeps the handle static with the holder after user manipulation. The holder can move the rod in a reciprocating or jigging fashion without user intervention. The holder can also move the rod in a different fashion following a fish strike on the rod. Moving patterns and specific behaviors following detection of forces associated with fish strikes can be stored in a local memory, potentially input by the user, and reproduced by the device. The holder can be moved by a drive such as a motor, spring, or other energy source without user interaction. The holder and any drive can be secured to a boat, ice, ground, dock, or any other mount via a lockable or traction-enabled base.

### RELATED APPLICATIONS

This application claims the benefit under 35 U.S.C. §119(e) to provisional application 61/938,820 filed Feb. 12, 2014.

### BACKGROUND

Fishing is performed in a variety of environments where access to fish-inhabited waters is possible, including from a boat, dock, pier, or other floating platform, or through ice, or trolling from a boat, for example. In each of these settings, a common technique is for the fisher to jig, or manually impart a steady reciprocation to, the bait or lure, for example, by lifting and dropping the end of the fishing pole with the line out and bait or lure in the water. Similarly, common devices exist that hold fishing poles with lures out while the fisher is away or monitoring several poles. Some holding devices may be able to simulate a simple jig to the bait by constantly lifting and dropping the pole or rotating the pole with the line out and even after a fish bites, tugs on the line, and/or consumes the bait, hook, or lure and attempts to swim away.

Simple jigging, such as a basic lifting and dropping of the line, is typically accomplished in holding devices by a gear, cog, or the like cut into a specific pattern that imparts a similar movement pattern on the fishing rod as the gear rotates. It is, however, preferred in the fishing art to manually jig the fishing rod, directly by the fisher's hand, so that the fisher can adjust or adopt a specific jig based on the fishing conditions and his or her desired jigging pattern and idiosyncrasies for best fishing.

### SUMMARY

Example embodiments include devices that hold and move fishing rods without human intervention. Embodiments can include a holder that receives the fishing rod handle and securely keeps the handle and rod while the user is not interacting with the device. The holder can be automatically moved, such as by a motor, spring, or other driving device, in a desired fashion to enhance fishing without user interaction. For example, a drive can selectively connect to and rotate the holder and rod therein to mimic a jigging motion to a line cast from the rod, attracting fish. The drive can disconnect from or otherwise stop moving the holder when a force associated with a fish bite pulls on the rod and thus the holder, and the holder may go limp or be otherwise moveable once the fish has bitten. Or for example, the drive, hook-setting catches, and/or blocks may permit a particular amount of free rotation of the holder but then resist movement at times likely to set a hook in a biting fish's mouth. The holder and any drive can be securely mounted to a base that may further lock to or be secured to with a mounting surface like a boat, ice, ground, dock, etc.

Holders of example embodiment devices can be specifically shaped to match and hold a fishing rod. For example holders may include a simple two-yoke design with upper and lower yokes that together surround and seat against the rod handle. The yokes can be staggered or spaced horizontally to allow easy and secure insertion of the fishing rod and accommodate a reel of the fishing rod between the yokes. The holder can be attached via a pivot point to the base, and the yokes may further be angled opposite a likely direction of rotation of the holder so as to secure the rod in the holder in case of a fish bite. The yokes may permit adjustment of a fishing pole to balance the same, or to provide a certain amount of default bias, against the base and/or a line with lure or bait.

Example embodiments may be programmable and include sensors to trigger desired functions as well as user interfaces to allow user selection of desired functions. For example, a user may manually jig the holder with a fishing rod in it under a learning setting of the device, and the movement pattern may be stored in a memory of the device. The user may then initiate automatic movement of the device, and the device, through a processor and drive, may move the holder and thus the pole to mimic the user's movements, without further user interaction. Example embodiment devices may further disengage the automatic jigging motion, engage a hook-setting motion, and/or allow free rotation of the holder pole upon events detected by the sensors, including fish strikes or user intervention, for example.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment pole retaining device.

FIG. 2 is another illustration of the example embodiment pole retaining device.

FIG. 3 is an illustration of another example embodiment pole retaining device.

FIG. 4 is an illustration of an example embodiment selective mating.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, “and” and “or” are equivalent to the term “and/or,” which includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange routes between two devices, including intermediary devices, networks, etc., connected wirelessly or not.

As used herein, the singular forms “a”, “an” and “the” and the plural form “indicia” are intended to include both the singular and plural forms, unless the language explicitly indicates otherwise. It will be further understood that the terms “comprises,” “comprising,” “includes,” and/or “including,” when used herein, specify the presence of stated features, integers, steps, operations, elements, and/or components, but do not themselves preclude the presence or addition of one or more other features, integers, steps, operations, elements, components, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

The inventor has recognized that devices that hold and automatically jig fishing poles do not permit a human user directly or in real-time to adjust or alter the jigging, as would be possible if the pole were being held in the user's hands. Rather, typical pole holders perform a simplistic and constant jigging that is not customizable, adjustable, interchangeable, or combinable with individual, user-created jigging patterns based on circumstances or user desires.

Typical pole holders further do not alter jigging based on a fish bite or hook setting into the fish, causing the pole to continuously reciprocate—raise and lower—the bait or lure on which the fish has already hit. The inventor has recognized that continuous jigging following a fish strike or initial or investigatory bite on a lure or bait will alarm the fish as it detects large and/or unnatural motion and resistance on the line through the struck lure or bait due to the continuous jigging in existing retaining devices. Particularly as the fish consumes the bait or begins to swim away with a hook in its mouth, this resistance may alarm the fish. An alarmed fish is much more likely to discontinue consuming the bait, expel any hook, and/or quickly flee. Thus, existing devices that continuously jig without setting a hook or releasing a line following a bite substantially increase the odds of an interested fish becoming alarmed and reduce the odds that a hook or other retention mechanism will set and anchor in the fish, which is typically necessary to reel in and catch the fish. To overcome these newly-recognized problems as well as others, the inventor has developed apparatuses that allow highly-specific and customizable unattended jigging, based on any individual fisher's desired pattern of motion, in a manner that will set the hook and/or not alarm a fish that has hit on a jigging lure or bait with hook.

The inventor has further recognized that devices that hold and automatically jig fishing poles do not permit easy yet secure, and potentially locked and theft-deterrent, pole engagement and retention as well as removal. Typical pole holders surround a pole handle from multiple sides, and/or from a large surrounding base, requiring tedious insertion and locking of a fishing pole from a specific orientation within a holding device.

Typical pole holders further do not readily attach to multiple surfaces or adjust about several different angles or orientations, potentially requiring poles inserted therein to be cast at undesirable angles or be unworkable in varied circumstances often encountered in fishing. To overcome these newly-recognized problems as well as others, the inventor has developed apparatuses that are highly flexible and permit pole insertion and adjustment from several different positions as well as permitting pole retention as several different desired orientations and positions for fishing.

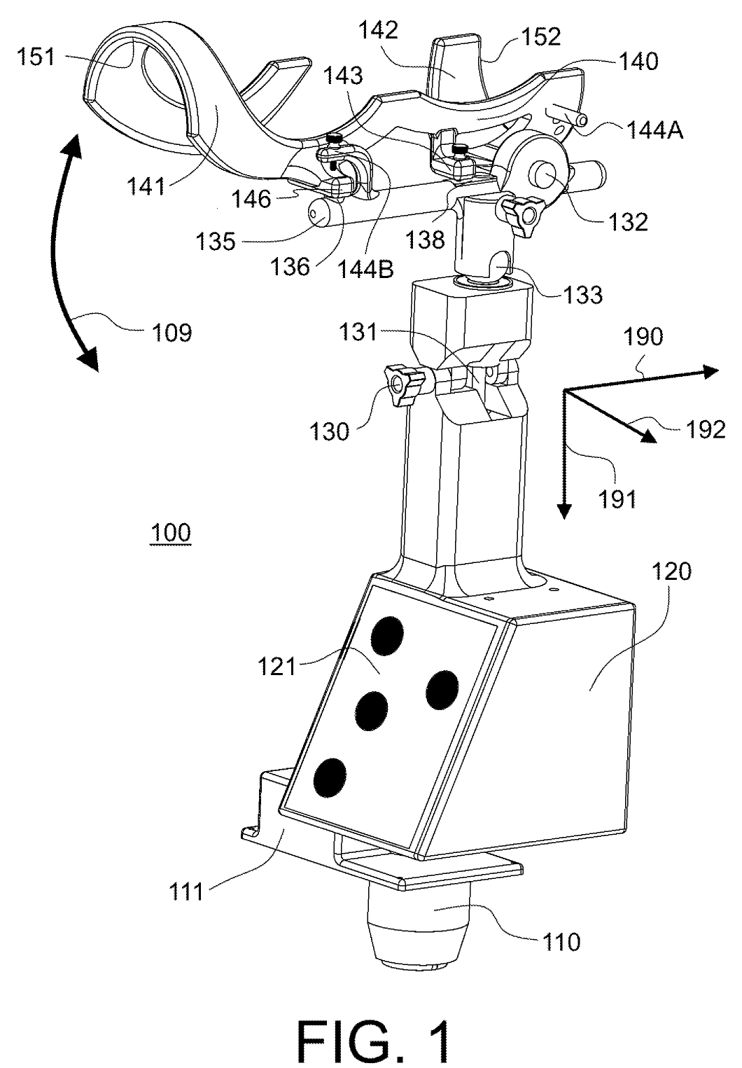

FIG. 1 is an illustration of an example embodiment pole retaining device 100. As shown in FIG. 1, device 100 includes a rod holding arm 140 sized and shaped to receive a fishing rod (not shown) and retain or secure the same statically relative to rod holing arm 140. Rod holding arm 140 may be relatively open, without numerous latches, fasteners, locks, etc. to hold a fishing rod. For example, rod holing arm 140 may include a top yoke 141 and bottom yoke 142 spaced apart in a horizontal direction 190, which may be a direction of casting and/or rod extension. Similarly, depth direction 192 and vertical direction 191 may be perpendicular to horizontal direction 190 in FIG. 1.

Yokes 141 and 142 may be spaced to accommodate a reel and spool common to fishing rods falling between the two yokes 141 and 142, and may be further spaced to permit some movement/repositioning of a rod in the direction 190. Top yoke 141 may be positioned farther back in direction 190 to extend over a top, more rearward position of a fishing rod, while bottom yoke 142 may be positioned more frontwards in direction 190 to support a bottom, more forward position of a fishing rod inserted in yokes 141 and 142.

A fishing rod may be readily inserted into rod holding arm 140 and into yokes 141 and 142 without moving securing pieces, straps, clamps, etc. For example, a fishing rod may be passed with a back end under top yoke 141, and a more forward portion of the rod may rest in bottom yoke 142. Any reel, spool, casting lock, and/or any other rod feature may rest in front of, behind, or between top yoke 141 and bottom yoke 142 and be freely accessible.

Because a fishing rod may have a center of mass in front of bottom yoke 142 in direction 190, and because a fishing rod may be subject to fish pulling or water forces at an end in direction 190, lower yoke 140 may serve as a fulcrum, with top yoke 141 counterbalancing these forces to keep a fishing rod seated in rod holding arm 140. The open, separated shape of yokes 141 and 142 permits easy insertion of a fishing rod therein from several different approach positions, and the positioning and shape of yokes 141 and 142 further permits adjustment of a rod inserted therein back from or toward direction 190. In this way, a user may position a fishing rod forward and backward in direction 190 to shift a center of mass of the rod relative to any fulcrum. This allows a desired level of torque in rod holding arm 140 and/or force on top yoke 141. However, when a user is not manually directly handling the fishing rod, yokes 141 and 142 may retain and secure a fishing rod in holding arm 140 without possibility of movement relative to rod holding arm 140 in any direction under typical fishing forces and conditions.

Top yoke 141 and bottom yoke 142 may be angled with respect to a rod extending in direction 190 and/or may include angled surfaces that are somewhat nonparallel. When a fishing rod seated in rod holding arm 140 is struck or pulled by a fish or other force generally in direction 190 and downward, a rear edge 151 of top yoke 141 and a leading edge 152 of bottom yoke 142 may lock or dig into the fishing rod due to the angled orientation of yokes 141 and 140. Rear edge 151 and leading edge 152 may be sharpened or include higher-friction surfaces to enhance this locking or holding action as a rod rotates against edges 151 and 152 when pulled by a fish.

Although rod holding arm 140 is shown with only two yokes 141 and 142 that allow manual repositioning of the rod in direction 190 while otherwise retaining the rod statically in rod holding arm 140, it is understood that additional locks, straps, high-friction surfaces, latches, adhesives, clamps, etc. may be added to any yokes 141 and 142 or any other part of rod holding arm 140 to achieve a desired securing between a fishing rod and rod holding arm 140. Similarly, although FIG. 1 shows an example embodiment pole retaining device 100 with one rod holding arm 140 shaped to receive one fishing rod, it is understood that multiple rod holding arms 140 and/or multiple yokes 141/142 in a single arm could accommodate multiple rods, potentially all at distinct positionings, in a single device.

As shown in FIG. 1, example embodiment device 100 further includes a drive arm 135. Although separate from, and moveable relative to, rod holding arm 140, drive arm 135 is positioned to match features of rod holding arm 140 and discriminately convey force and movement to rod holding arm 140. For example, both rod holding arm 140 and drive arm 135 may share a pivot point 132. In this way, both rod holding arm 140 and drive arm 135 may be rotatable about pivot point 132 as shown by rotational direction 109, which may be rotational about an axis of depth direction 192. For example, pivot point 132 may be a separated or telescoping axle with hub extending generally in depth direction 192 that permits independent rotation of drive arm 135 and rod holding arm 140 in direction 109. Or drive arm 135 and rod holding arm 140 may have different connection points but be otherwise static with respect to each other in desired dimensions.

Drive arm 135 is rotatable in direction 109 and configured to selectively transmit such movement or force to rod holding arm 140. For example, if drive arm 135 is rotatable about pivot point 132 in direction 109, this may translate to a component of vertical movement in direction 109 for an end of drive arm 135.

Such movement and force from drive arm 135 can be transmitted to rod holding arm 140 in a variety of ways. For example, opposing magnets 146 and 136 respectively in rod holding arm 140 and drive arm 135 may be positioned to directly touch or be located near enough to exert corresponding magnetic forces on each other and thus couple rod holding arm 140 and drive arm 135. For example, as drive arm 135 rotates back and forth in direction 109, an end with drive magnet 136 moves vertically up and down in direction 109. Correspondingly, rod holding arm 140—through contact or magnetic attraction from holding magnet 146—may move with drive arm 135 in direction 109. Such movement may accomplish desired jigging of a fishing pole seated in rod holding arm 140, resulting in a more life-like lure or bait in the water that is more likely to attract a fish's attention.

Drive arm 135 can be controlled to move and transmit force in a variety of ways and under a variety of mechanisms. For example, as shown in FIG. 1, drive arm 135 can rotate about a common pivot point 132. Similarly, drive arm 135 may strictly vertically raise and lower in direction 191 to push an end of rod holding arm 140 in a jigging fashion. Force and movement of drive arm 135 can be provided in any way, including a local motor, through a wound spring, by direct user manipulation, etc. For example, as shown in FIG. 1, flexible transmission 131 may extend from a motor or other gearbox in control mount 120 and connect to ball-and-socket joint 133 and/or drive arm 135 to mechanically rotate the same and thus serve as a transmission between a force element in control mount 120 and drive arm 135.

Drive arm 135 may cease to impart motion to rod holding arm 140 at desired times. For example, when a fish initially strikes a bait or lure cast from a fishing rod in rod holding arm 140, or when a fish is hooked on such a fishing pole and begins to swim away, or when a bait or lure has become entangled with a water hazard, etc. it may be desirable to stop jigging the bait or lure. Indeed, a fish striking or consuming a bait or lure may be very sensitive to jigging and resulting resistance from the bait or lure once in contact with the same, and a striking fish may flee or spit out any bait or lure that gives unnatural resistance before any hook is set. Thus, when a fish strike is detected on a fishing pole in rod holding arm 140, or any other threshold force is encountered by rod holding arm 140, drive arm 135 may stop imparting any force to rod holding arm 140, and rod holding arm 140 may freely rotate. In this way, a fish may be subject to and detect no or significantly less force or unnatural pull or resistance in any lure or bait cast therefrom following a strike.

Selective discontinuance of jigging or any other motion imparted upon rod holding arm 140 by drive arm 135 may be accomplished in several ways. For example, magnets 136 and 146 may have a known magnetic strength and be positioned at a known distance from pivot point 132 such that magnets 136 and 146 will break contact as a fish strikes. That is, the force and thus torque imparted on rod holding arm 140 from a fish strike may cause an upward force at magnet 146 greater than a downward magnetic force from magnet 136, and arms 140 and 135 will separate with no further force or motion being transmitted between the two.

The threshold strike force required to separate arms 140 and 135 may have an easily-adjustable and broad range. For example, when using magnets 146 and 136, an adjustable separating arm 143 may further be used to create a variable distance between magnets 136 and 146. Due to the distance, any magnetic force and thus threshold separating force between magnets 136 and 146 is less. A user may move, such as through a threaded screw or lever, separating arm 143 to create a desired separation and thus separating force threshold between magnets 136 and 146. Further, a user may adjust a casting position of a pole in rod holding arm 140 to further manipulate the threshold separating force. For example, setting a rod farther forward in direction 190 in rod holding arm 140 may increase the default bias of the rod against upper yoke 141 and thus lessen the required additional strike force on the rod to separate arms 140 and 135. Similarly, setting a rod farther back in direction 190 in rod holding arm 140 may compensate for a line weighted with sinkers or a heavier lure or hook and bait. Similarly, if magnets 136 and 146 are electromagnets, their attractive force may be adjusted by changing a current flowing in the two. In these and other ways, a user may fine tune the requisite separating force between arms 140 and 135 over a relatively large range. If magnets 136 and 146 are strong, such as rare earth magnets or electromagnets, the range of required threshold force to separate the two can be further enlarged and adjusted at several fine degrees through user manipulation of arm separation, pole positioning, magnet strength, etc.

Fine tuning over a broad range can offer a desired and/or optimal relationship between force required to separate arms 140 and 135 and opposite force imparted by a fish hitting the bait or lure. This permits a user to determine and accurately achieve a specific threshold force that will discontinue jigging and thus not alarm a striking fish. For example, a fisher may separate magnets 146 and 136 by adjusting separating arm 143 until a desired level of pull on an end of a pole retained in rod holding arm 140 is reached; this desired level may correspond to a known level of pull from a desired species of fish for example or other metric. Similarly, knowing default distances between pivot point 132 and magnets 136 and 146, strength of magnets 136 and 146, as well as expected rod lengths and typical forces from fish strikes on a bait or lure, separating arm 143 may be marked at threshold distances that cause separation and thus cease jigging for likely fish strikes, potentially with several markings based on type of fish or fishing conditions.

Once the threshold force is encountered from a fish strike or other desired phenomenon, rod holding arm 140 can move relatively freely in direction 109, and a fishing pole situated in rod holding arm 140 may be able to rotate, with a casting end rising and lowering, while spooling out without significant force or resistance. This cessation of jigging and resistive force may cause a biting fish to remain unalarmed and thus continue to bite or consume any bait or lure and increase a likelihood of a hook being set in the fish's mouth or body. In order to allow such free movement of rod holding arm 140, drive arm 135 may move out of contact with rod holding arm 140 or otherwise deactivate/stop imparting any force or motion to rod holding arm 140.

For example, a contact sensor 138 in drive arm 135 may detect contact between separating arm 143 and drive arm 135, such contact indicating arms 140 and 135 are coupled and jigging or otherwise moving together. When contact sensor 138 detects no contact with separating arm 143, this may correspond to separation following a strike or other threshold event. When sensor 138 detects such lack of contact, drive arm 135 may deactivate and/or drop down where it will not contact or interact with rod holding arm 140. Or, for example, when no contact is detected by sensor 138, an electromagnet or other coupling mechanism may be deactivated. Sensor 138 may also be positioned in or include detectors in catches 144, in which case detecting contact may indicate arms 140 and 135 have decoupled following a fish strike.

Detection in sensor 138 can be accomplished in several ways, such as through an electric circuit, mechanical latch, etc. that changes with contact. Sensor 138 may further be incorporated into electromagnets as magnets 146 and 136, which may deactivate immediately upon self-detection of separation. Because magnetic attraction decreases rapidly with distance and requires no direct contact to transmit force, magnets 136 and 146 may provide a relatively clear separation threshold without further interaction following such separation. Similarly, magnets 136 and 146 may be of a same polarity and repel, for example, magnets 136 and 146 may be electromagnets with reversible polarity based on current. In this way magnets 136 and 146 may force arm 140 and 135 apart and/or provide a gradual buffering to prevent arms 140 and 135 from hitting or contacting. Polarity and attraction between magnets 146 and 136 may be similarly controlled, adjusted, reversed, initiated, etc. in response to sensor 138 or other input corresponding with a desired change in attraction between arms 140 and 135.

Alternatively or additionally, once the threshold force is encountered from a fish strike or other desired phenomenon, an additional hook-setting force may be imparted to rod holding arm 140. Specifically, once a fish has proceeded from striking to consuming a bait or lure and potentially swimming off, an associated hook is likely within the fish's mouth. It may be desirable to set the hook in the fish's body at that time by a sudden, single reverse force or raising of the fishing rod without additional motion or alarming resistance.

Rod holding arm 140 may include a hook-setting catch 144A and/or 144B that provides a hook-setting force and/or limits rotation of rod holding arm 140 so that any fishing rod therein does not touch the water due to a fish hooked on the rod following an initial fish strike or other threshold event. Limiting such contact may prevent or reduce ice buildup on the rod in freezing temperatures and/or reduce or prevent excess force on the rod, such as from moving water while trolling from a moving boat, that may break or damage the fishing rod. For example, following a fish strike and decoupling of arms 140 and 135, rod holding arm 140 may be significantly rotated clockwise in direction 109, as the strike force from the casting end in directions 190 and 191 rotates arm 140. Hook-setting catches 144A and/or 144B may suddenly stop further rotation in the clockwise 109 direction of rod holding arm 140.

For example, extension catch 144A may extend in depth direction 192 to contact an end of support arm 135 or other additional stationary stop. As rod holding arm 140 rotates downward until extension catch 144A contacts support arm 135, support arm 135 may block further movement of rod holding arm 140 and serve as a reverse pull or force that sets a hook in the fish's body after initial strike and consumption of a bait or lure. Hook-setting extension catch 144A may thereafter disengage or otherwise allow relatively free rotation of rod-holding arm 140. As seen in FIG. 1, extension catch 144A may be adjusted between several potential positions to permit a user to decide on a degree of rotation in direction 109 after which a rod should be subject to a setting stop from extension catch 144A before over rotation.

Or, for example, drive arm 135 may include a coupling catch 144B that provides a reverse pull for force for setting a hook following initial fish strike. For example, following a fish strike and decoupling of arms 140 and 135, drive arm 135 may significantly rotate counterclockwise in direction 109, such as through deactivation from triggering of sensor 138. Coupling catch 144B may be positioned between magnet 136 and sensor 138 and may be shaped to contact or catch separating arm 143 and/or magnet 146 when rotating with drive arm 135. This catching may pull rod holding arm 140 counterclockwise in direction 109, lifting a rod tip and setting a hook. Coupling catch 144B may thereafter disengage or otherwise allow relatively free rotation of rod holding arm 140. Alternatively, coupling catch 144B may maintain arms 140 and 135 in a non-static rotational couple. For example, following disconnection form a strike, sensor 138 may detect the disconnection and drive arm 135 may have no force associated with it, allowing rod holding arm 140 to continue to rotate in direction 109 without resistance. Or drive arm 135 may execute a quick hook-setting reverse pull in downward direction 109 and thereafter become free, transmitting the same hook-setting action followed by low-resistance rotation to rod holding arm 140 and a fishing rod therein.

Rod holding arm 140 and drive arm 135 may be oriented and repositioned in several different ways. For example, as shown in FIG. 1, rod holding arm and/or drive arm 135 may extend from control mount 120. A rotational release 130 may permit articulation of drive arm 135 and/or rod support arm 140 about an axis in the casting direction 190 or any other axis. For example, rod holding arm 140 and drive arm 135 may be rotated about an axis in horizontal direction 190 and locked by rotational release 130 at any rotated position, potentially allowing paired jigging in a depth direction 192 instead of, or in addition to, vertical direction 191. Similarly, a ball-and-socket joint 133 may permit arms 140 and 135 to be rotated about any axis. For example, arms 140 and 135 remain oriented in the vertical direction 191 while rotational release 130 is rotated about an axis in the horizontal direction 190, effectively allowing arms 140 and 135 to translate in the depth direction 192. Or arms 140 and 135 may be completely rotated 180 degrees about any axis in order to orient arms 140 and 135 in an opposite direction.

As such, ball-and-socket joint 133 permits orientation and thus casting, jigging, and all other operation, of example embodiment device 100 in any backward or forward direction based on fishing circumstances. Further, both rotational release 130 and ball-and-socket joint 133 may hold components of example embodiment device 100 static when not being directly manipulated by a user, allowing various orientations to be maintained in operation and/or release 130 and joint 133 may permit movement only in desired directions during operation.

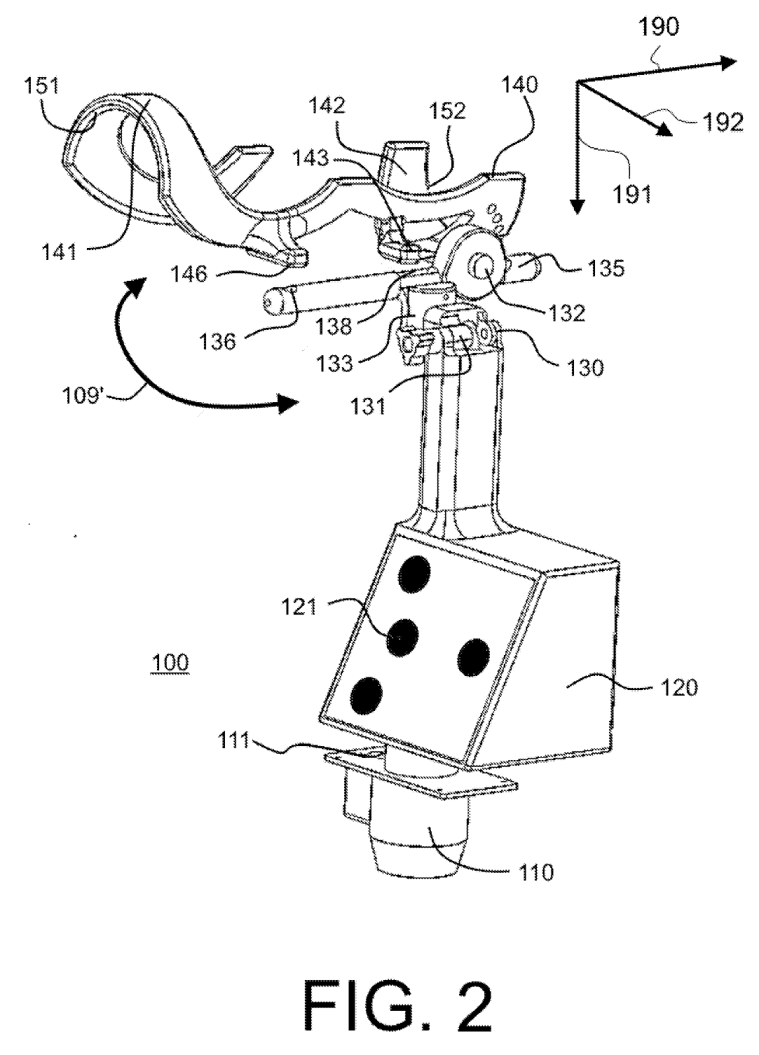

FIG. 2 is another illustration of example embodiment pole retaining device 100. As shown in FIG. 2, catches 144A and 144B have been detached; however, catches 144A and/or 144B may still be readily replaced without modification of device 100. As further shown in FIG. 2, ball-and-socket joint 133 has been rotated, such as via rotational release 130, 90 degrees to a horizontal orientation, but arms 140 and 135 may remain vertical due to the freely rotatable nature of ball-and-socket joint 133. In the example of FIG. 2, ball and socket joint 133 may still be rotated or reciprocated by a remote or local power source in direction 109 (FIG. 1); however, because ball and socket joint 133 has been rotated about an axis in horizontal direction 190, its axis of rotation for reciprocation is now in a vertical direction 191. This may result in drive arm 135 thus being rotated back in forth in direction 109′ about an axis in vertical direction 191 so as to provide horizontal jigging of rod holding arm 140 and a pole therein, which remain otherwise upright. Of course, other rotations, positionings, and orientations of ball-and-socket joint 133 and rotational release 131 are possible, to achieve jigging and positioning in any dimension in example embodiment device 100.

Horizontal jigging in direction 109′ permitted by rotating arms 140 and 135 about rotational release 130 and/or ball-and socket joint 133 may be particularly useful when trolling behind a boat to permit wide horizontal sweeping of the trolling line and bait or lure. Any number of additional extending or telescoping members and rotational elements may be paired with arms 140 and/or 135 to achieve any desired positioning and orientation of a fishing rod in rod holding arm 140. Flexible transmission 131 may be capable of repositioning or snaking through to any of these positions in order to transmit power in any orientation, if a force element is remote from drive arm 135 or ball-and-socket joint 133.

As shown in FIG. 1, example embodiment device 100 may further include control mount 120 with a power element, computer processor and memory, and/or user controls that power and/or control support arm 135 and additional components of device 100, such as ball-and-socket joint 133, rotational release 131, sensor 138, magnets 146 and 136, etc. For example, control mount 120 may include a motor, battery, actuator, or other power element that provides power and/or motion to support arm 135, potentially through flexible transmission 131. Control mount 120 may further include a memory and processor coupled with the power actuator to control a degree and/or pattern of rotation of drive arm 135 in direction 109.

For example, control mount 120 may be programmed with several different default motions for drive arm 135, including frequencies, magnitudes, and other patterns of motion in direction 109 or other ranges of motion of drive arm 135. Such programmed patterns of motion may be selectively transmitted to rod holding arm 140 and thus result in specific types of jigging in the line and any lure or bait cast therefrom. Control mount 120 may be further programmed to move drive arm 135 based on input from sensor 138. For example, if coupling catch 144B is in use, a motor in control mount 120 may be activated to rotate drive arm 135 counterclockwise in direction 109 following receipt of a disconnection signal from sensor 138 And the motor may shortly thereafter disengage, thus achieving a hook-setting pull on rod holding arm 140 followed by free rotation. Of course, other motion patterns and engagement/disengagement settings may be stored and executed in a processor, memory, and motor in control mount 120.

Control mount 120 may further include a transducer or other position detection device capable of recording motion of drive arm 135 and/or rod holding arm 140 in a memory in control mount 120. In this way, a user may manually move or jig rod holding arm 140 paired with drive arm 135 in a desired pattern over several seconds, and positional signals may be transmitted to a sensor or transducer in control mount 120, potentially via flexible transmission 131, and these signals maybe recorded in an associated memory. Or motion may be input through a knob or other control 121 that corresponds to a type of jigging. A processor may write these signals received as input, thus storing data that corresponds to a position of rod holding arm 140 coupled to arm 135 over time in an associated memory as a jig.

A stored motion pattern may then be copied from memory by a powering element such as a processor and motor, in control mount 120, allowing a user to record and “replay” desired jigging patterns via rod holding arm 140. Several different patterns of motion over time may be recorded as specific jigs for a user to select and execute depending on fishing circumstances. In this way, jigging of a fishing rod by example embodiment device 100 may reflect an individual's desired jigging pattern, reflecting individual judgment as to fishing conditions and best or idiosyncratically-desired motions optimized for fishing, without the user having to manually jig and attend the rod.

Control mount 120 may further include a processor, memory, and/or other circuitry that powers and operates sensor 138, magnets 146/136, or other powered feature of example embodiment device 100. For example, a programmed processor may relay signals from sensor 138 into a cutoff action for a power supply for drive arm 135. Or, for example, a programmed processor may initiate a visual or audible alarm upon receipt and processing of a signal from sensor 138 indicating disengagement of arms 140 and 141 or other important detections. Control mount 120 may include a user interface 121 or user controls to permit a user to control any aspect of example embodiment device 100. For example, a user may interact with controls 121 on control mount 120 to selectively store/record desired jigging patterns in an associated memory and “replay” stored patterns and/or default jigging patterns. Or a user may select with interface 121 a desired level of force required to separate arms 140 and 135 based on magnet strength, separation of arms, or other controllable parameters of example embodiment device 100.

As shown in FIG. 1, device 100 includes a base 110 that can mount on several desired surfaces. For example, base 110 may attach to a fishing well, gunnel, or rail of a boat or be a stand-along base that supports example embodiment device 100 and a fishing rod secured therein. For example, base 110 may clamp to, be inserted in, or lock with a stationary structure. Of course, base 110 may be rotatable or extendable to further allow rod positioning and jigging in any desired position or orientation. Base 110 may include a lock 111 that secures example embodiment device 100, and potentially a fishing rod secured therein, to a permanent structure such as a boat, dock, etc. and may be operable with a key or other credential that allows only selective removal of device 100 from the permanent structure.

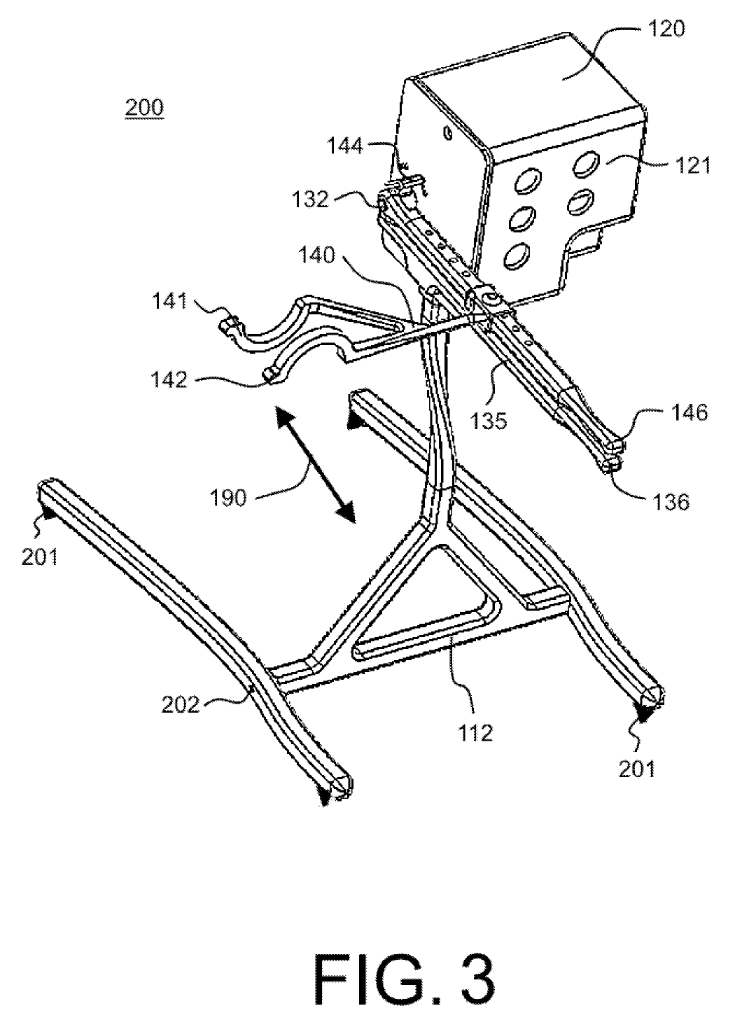

FIG. 3 is an illustration of a different example embodiment pole retaining device 200. As shown in FIG. 3, example device 200 may include any or all same structures as device 100 in FIG. 1 with like numerals, shown or not shown, embodied in different fashions. For example, rod holding arm 140 may be extendable in direction 190 and lock at any desired extension with respect to drive arm 135, providing differing amounts of counterbalancing and thus force required to break a connection between arms 135 and 140. Rod holding arm 140 shown in FIG. 3 may be sufficiently separated from drive arm 135 and yokes 141 and 142 to accept either right or left-handed fishing rods. Because rod holding arm 140 may use a single, combined axis for both yokes 141 and 142 and a shared pivot point 132 with drive arm 135, rod holding arm 140 may be capable of balancing a fishing rod and arms 140 and 135 on a single axis without need for external drives or forces to keep these components at desired positions.

Similarly, double base 112 may be wider and larger, accommodating setting up example embodiment device 200 on the ground or as a stand-alone structure with sufficient weighting or other ground attachment. Further, double base 112 in FIG. 3 may support multiple iterations of arms 135 and 140 with individual control mounts 120. Double base 120 may include one or more cleats 201 that can be driven into the ground, wood, ice, or another surface and securely mount example device 200 thereto without movement. Double base 120 may further include one or more hinges 202 that permit example embodiment device 200 to collapse into a relatively single plane in direction 190 and 192 (FIG. 1) after arms 135 and 140 are rotated fully downward. Such collapsing may permit easy carrying of example embodiment device 200 by the collapsed double base 120. For example, in a streamlined embodiment, only double base 112, rod holding arm 140, and a simplified control mount 120 may be connected without motors or additional components to provide a more mobile yet sturdy fishing pole holder that balances and secures the pole in rod holding arm 140 balancing and rotating on a single point of rotation.

Although drive arm 135 is shown in example embodiments translating desired and selective motion to rod holding arm 140 through direct contact and/or magnetic force, it is understood that several other arrangements and embodiments of drive arm 135 can supply a desired jigging motion to rod holding arm 140 that ceases upon fish strike. For example, jigging drives can be selectively engaged with a held fishing rod through other structures or even a computerized motor capable of sensing resistance and position. Such a device may jig the holding arm and rod by a computer-controlled drive such that arms 135 and 140 are a single structure, and, when detecting to a striking force, the drive may release the arm for free rotation and/or desired hook-setting.

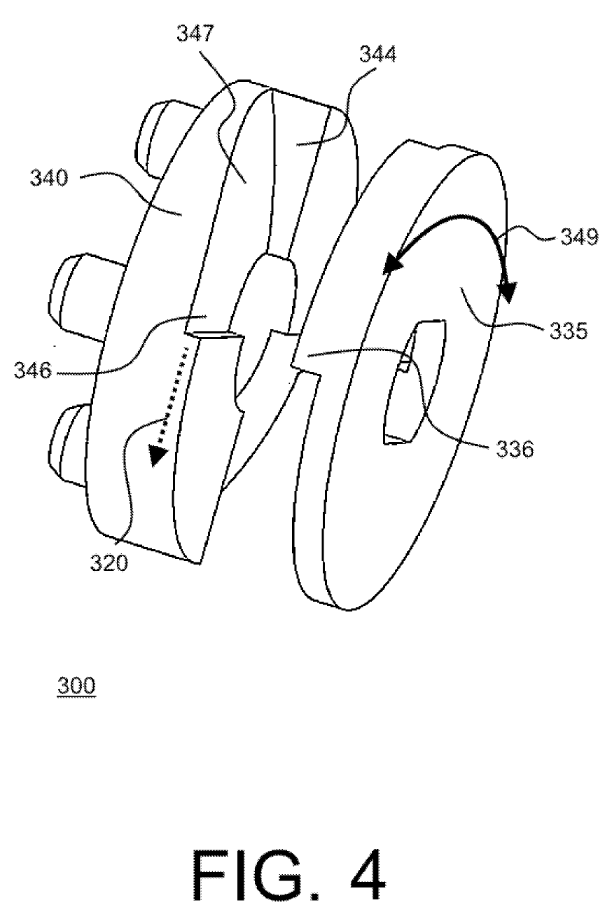

Still further, FIG. 4 is an illustration of another arrangement to supply a desired jigging motion with example embodiment selective mating 300 between a holding bushing 340 and a drive bushing 335. For example, holding bushing 340 may be connected or integral with a rod holding arm, while drive bushing 335 may replace or serve as a drive arm, connected to a motive or power source that rotates drive bushing 335.

As shown in FIG. 4, drive bushing 335 may include a raised connection edge 336 that frictionally seats against friction surface 346 of holding bushing 340. Friction between edge 336 and surface 346 may couple the two, and as drive bushing 335 rotates in direction 349, holding bushing 340 may rotate equally. This paired rotation may result in the desired jigging described in connection with other example embodiments. Upon a fish strike or other threshold force in direction 320 on holding bushing 340, however, frictional contact between surface 346 and edge 336 may be broken. In this instance, a lower surface 347 may permit holding bushing 340 to rotate freely once separated from edge 336. Because friction surfaces 336 and 346 may wear over time due to continuous use, drive busing 335 and holding bushing 340 may be removable and therefor replaceable.

Alternatively, a setting edge 344 may be paired with edge 336 to permit only a limited degree of free rotation before a sudden block, serving as a setting force similar to the functionality of hook-setting catch 144 (FIG. 1). The threshold force required to uncouple bushings 335 and 340, and thus any arms and fishing poles connected thereto, may be adjusted by changing the bias of holding bushing 340 against drive bushing 335. Similar to embodiments with magnets or other selective release structures, a user may adjust the degree of force between bushings 335 and 340 to achieve a desired releasing force that corresponds with a fish strike.

Further variations of example embodiments are possible. For example, the structures of U.S. provisional application 61/938,820 filed Feb. 12, 2014 are incorporated herein in their entireties and may overlap with, be useable in place of, and/or show variations of individual and multiple components of example embodiments described herein.

Some example embodiments being described here, it is understood that one or more examples and components thereof may be used in combination and/or in duplication to provide multiple rod handling devices with unattended, selective jigging. It will further be appreciated by one skilled in the art that example embodiments may be varied through routine experimentation and without further inventive activity. For example, although some examples rely on relatively positioned structures to selectively convey force, it is understood that a single arm with a computerized scale may be used to determine when a threshold force corresponding to a strike has occurred and release the arm accordingly. Variations are not to be regarded as departure from the spirit and scope of the exemplary embodiments, and all such modifications as would be obvious to one skilled in the art are intended to be included within the scope of the following claims.

What is claimed is:

1. An apparatus for retaining and reciprocating an unattended rod, the apparatus comprising:
a holder shaped to receive a handle of the rod and secure the rod with the holder;
a drive selectively connected to the holder, wherein the drive is configured to move the holder until a threshold force impacts the rod in the holder, and wherein the drive is configured to disengage from the holder at the threshold force such that the holder and the rod are freely moveable, and wherein the threshold force is that of a fish striking a lure in water attached to an end of the rod opposite the handle.
a base connected to the holder and the drive.

2. The apparatus of claim 1, wherein the drive is configured to move the holder in a reciprocating rotation in a single plane, and wherein the holder is freely moveable in the rotation following disengagement from the drive.

3. The apparatus of claim 2, wherein the holder is moveable only in the rotation in the single plane relative to the holder and the base while unattended.

4. The apparatus of claim 1, wherein the drive includes a motor connected to an arm positioned with the holder so as to move the holder with the motor via the arm.

5. The apparatus of claim 4, wherein the holder includes a first magnet, wherein the arm includes a second magnet, and wherein the first and second magnet are positioned to exert magnetic attraction on each other as the arm moves from the motor.

6. The apparatus of claim 5, wherein the arm and the holder share a pivot point so as to rotate together, and wherein the magnets are positioned and of a magnetic strength so as to separate at the threshold force.

7. The apparatus of claim 1, further comprising:
a catch configured to block free movement of the holder beyond a threshold distance.

8. The apparatus of claim 7, wherein the catch is further configured to repair the drive and the holder following the threshold force.

9. The apparatus of claim 1, further comprising:
a sensor positioned to detect when the holder has disengaged from the drive, wherein the drive is connected to the sensor and is configured to deactivate when the sensor has disengaged from the drive.

10. The apparatus of claim 9, wherein the drive includes an arm positioned with the holder so as to move the holder, wherein the arm and the holder share a pivot point so as to both rotate in a single plane and be otherwise stationary with respect to the base, and wherein the drive is configured to stop moving the arm when the sensor detects the holder has disengaged from the drive.

11. The apparatus of claim 1, wherein the holder includes a first yoke and a second yoke, and wherein,
the rod is a fishing rod extending horizontally when inserted into the holder,
the first and second yoke are shaped to seat against a handle of the fishing rod,
the first yoke extends vertically above the second yoke,
the first yoke is positioned behind the second yoke horizontally so as to space the first and the second yoke to permit insertion of the fishing rod and a reel of the fishing rod in the first and the second yoke.

12. An apparatus for unattended holding of a fishing rod with cast line and lure, the apparatus comprising:
a holder including a first yoke and a second yoke, wherein,
the first and second yoke are shaped to seat against a handle of the fishing rod,
the first yoke extends vertically above the second yoke,
the first yoke is positioned behind the second yoke horizontally so as to space the first and the second yoke to permit insertion of the fishing rod and a reel of the fishing rod in the first and the second yoke; and
a base configured to anchor to a mounting surface, wherein the holder is connected to the base and rotatable with respect to the base.

13. The apparatus of claim 12, wherein the holder is moveable horizontally with respect to the base.

14. The apparatus of claim 12, wherein the first yoke includes a first angled surface and where the second yoke includes a second angled surface, wherein the angled surfaces are angled oppositely of a direction of rotation of the fishing rod when inserted in the holder and pulled by a fish.

15. The apparatus of claim 12, further comprising:
a motor connected to the holder and configured to reciprocate the holder relative to the base.

16. The apparatus of claim 15, further comprising:
a joint between the holder and the motor, wherein the joint permits static positioning of the holder at an angle with respect to the base and permits changing a plane of the reciprocation;
a flexible transmission between the motor and the holder that transmits force for the reciprocating from the motor.

17. The apparatus of claim 15, further comprising:
an arm connected to the motor and positioned with the holder, wherein the arm reciprocates under force from the motor and causes the reciprocation in the holder, and wherein the arm is configured to disengage with the holder under a threshold force from a fishing rod inserted in the holder.

18. The apparatus of claim 12, wherein the base includes at least one of a cleat to securely penetrate into the mounting surface and a lock to prevent removal from the mounting surface.

19. The apparatus of claim 12, further comprising:
a plurality of the holders connected to the base.

20. A method of fishing, comprising:
receiving, with a computer processor from a human user, input of manual reciprocation of the fishing rod for an amount of time via a holder secured to the fishing rod;
storing the input in a computer memory; and
reciprocating, with a drive and the computer processor, the holder and fishing rod secured in the holder to mimic the manually reciprocating from the stored input; and
discontinuing, without cotemporaneous input from the human user, the reciprocation upon detection of a fish bite on the fishing rod.
